(19) United States
(12) Patent Application Publication
(10) Pub. No.: US 2006/0262808 A1
(43) Pub. Date: Nov. 23, 2006

(54) Methods and Systems for Fragmentation and Reassembly for IP Tunnels in Hardware Pipelines

(76) Inventors: Victor Lin, Fremont, CA (US); Vishwas Manral, Vasanth Nagar (IN)

Correspondence Address: PILLSBURY WINTHROP SHAW PITTMAN LLP, P.O. BOX 10500, MCLEAN, VA, 22102, US

(21) Appl. No.: 11/379,559

(22) Filed: Apr. 20, 2006

Related U.S. Application Data
(60) Provisional application No. 60/673,482, filed on Apr. 21, 2005.

(51) Int. Cl. H04J 3/16

(52) U.S. Cl. 370/466; 370/474

(57) ABSTRACT

A novel flow-through architecture for fragmentation and reassembly of tunnel packets in network devices is presented. The fragmentation and reassembly of tunneled packets are handled in the hardware pipeline to achieve line-rate processing of the traffic flow without the need for additional store and forward operations typically provided by a host processor or a co-processor. In addition, the hardware pipeline may perform fragmentation and reassembly of packets using encrypted tunnels by performing segment-by-segment crypto. A network device implementing fragment reassembly can include an ingress hardware pipeline that reassembles fragmented packets between a media access control (MAC) of the device and an output packet memory of the device, where the incoming fragmented packets can be encrypted and/or tunneled. A network device implementing packet fragmentation can include an egress hardware pipeline that fragments packets between an input packet memory of the device and the MAC, where the outgoing fragments can be encrypted and/or tunneled.

### CROSS REFERENCE TO RELATED APPLICATIONS

This application is related to and claims the benefit of U.S. Provisional Patent Application No. 60/673,482 filed Apr. 21, 2005 and is incorporated, in its entirety, herein by reference.

### BACKGROUND

1. Field of the Application

Generally, this application relates to communication networks. More specifically, it relates to methods and systems for fragmentation and reassembly for IP tunnels in hardware pipelines.

2. Description of the Related Art

In traditional networking environments, networking devices are connected by physical wires or wireless links. For example, L2 Ethernet networks are constructed using wired links, bridges and switches, and L3 IP networks are constructed by physically connecting multiple L2 Ethernet networks together using routers. To increase the flexibility and reduce installation overhead, tunneling technologies have been introduced to allow multiple nodes or networks to be connected via logical links instead of physical links. This allows network administrators to construct networks that are independent of the underlying physical topology, thus increasing the flexibility of the network topology. For example, network administrators can connect two disjoint networks in two different geographic locations by running an IP tunnel between two sites within the two networks. The two networks are transparent to the internetworking infrastructure between the two networks (e.g., the IP tunnel, etc.).

Tunneling technology is typically implemented by adding an encapsulation outside of the original payload, for example, an IP datagram. The encapsulating header is responsible for transporting the payload from one location to another location. Once the encapsulated payload reaches the destination, the network node decapsulates the packet, extracts the data out of the original payload, and processes the data like a regular, non-tunneled packet.

Tunnels are widely used in modem networking infrastructure. For example, the IP security protocol, IPSec, uses tunnels to form a secure connection between two networks or between a host and a network so they can be logically connected. Two disjoint Internet Protocol version 6, IPv6, networks can be connected by an IPv6-in-IPv4 tunnel so they can be connected even though there is no internetworking IPv6 between them (e.g., only IPv4).

Tunnels, especially IP tunnels, increase flexibility, but also create some problems. The biggest problem is that payload sizes normally increase in the tunnel encapsulation process. For example, IP-in-IP tunnel increase the payload by 20 bytes. If the original packet size is the same as the maximum transmission unit (MTU) size of the transmission link, the tunneled payload will exceed the MTU limitation by 20 bytes. To solve this problem, network protocols are typically designed to fragment the outgoing packets to ensure that the total transmission payload does not exceed the MTU size. During fragmentation, each packet is divided into multiple segments before it is sent out, where each segment does not exceed the MTU size. The tunnel termination node will then reassemble all of the received segments back to the original packet before extracting the payload and forwarding the original packet to the destination. This process is typically called IP fragmentation and reassembly.

FIG. 1 illustrates a typical generic routing encapsulation (GRE) tunnel protocol stack 100 as is known in the art today. As shown in FIG. 1, there are two physical interfaces 110, 120 and one logical interface 130, all three of which are attached to an IP stack 140. In operation, for example, on the reception side, tunneled packets that come in from physical interfaces 110 should be passed through IP stack 140 to GRE 150, and eventually decapsulated by a tunneling process 190. The inner IP packets of the decapsulated tunneled packets are then passed to IP stack 140 via logical interface 130, and can be forwarded to the destination via physical interface 120. On the transmission side, IP packets coming in from physical interface 120 can be forwarded to logical interface 130 via IP stack 140. Logical interface 130 can pass the IP packets to tunnel processing 190, which encapsulates the packet with GRE 150 and IP header before it is forwarded to physical interface 110 via IP stack 140.

Logically, the IP layer is responsible for the typical fragmentation and reassembly process, and should reassemble packets before passing the datagram to upper layer stacks (e.g., generic routing encapsulation (GRE) 150, transmission control protocol (TCP) 160, user datagram protocol (UDP) 170, IP Security Protocol (IPSec) 180, etc.). Likewise, if the packet coming from an upper layer exceeds the MTU size, the IP layer should fragment it before passing it to lower layer interfaces (e.g., physical interface 110, 120, logical interface 130, etc.).

There are generally two typical implementations for packet fragmentation and reassembly used in IP tunneling. Both implementations have at least some negative impact on latency or throughput, or both.

Switching processors typically pass packets to a separate host processor, or CPU, for additional fragmentation and reassembly processing. For example, during the reception process, if a packet fragment is detected by the switching processor, it passes the fragment to host CPU. The IP stack on the host CPU reassembles the IP fragments back together before it passes the reassembled packet back to the switching hardware for additional processing. During the transmission process, if the switching hardware detects that the packet size exceeds the MTU size for the outgoing interface, it again passes the packet to host CPU, which is then responsible for fragmenting the packet before sending the fragments back to an outgoing interface.

A drawback of this method is that all fragments will require slow path host CPU intervention. Host CPU processing is slower than inline, hardware processing. If the percentage of packets requiring fragmentation is relatively high within a given network, the total throughput of the network will slow down significantly. A second drawback of this typical implementation is latency and jitter. Fragmented packets will have much higher forwarding latency (normally on the order of milliseconds) compared with the latency of non-fragmented packets (normally on the order of microseconds). This increased latency can negatively affect latency-sensitive applications, such as, for example, streaming media and voice over IP (VoIP) applications. Another drawback of this implementation is out-of-order packet/fragment delivery. If a non-fragmented packet comes immediately after a fragmented packet, the second, non-fragmented packet will likely be forwarded out first, and the first, fragmented packet (once reassembled) will be forwarded second, via the host CPU. This creates out-of-order packet delivery that can negatively affect TCP application throughput.

The second typical fragmentation and reassembly implementation is to use a separate fragmentation and reassembly co-processor. If a fragmented packet is received from an interface, it is passed to the co-processor where fragments are stored in packet memory. After all the fragments arrive, the co-processor reassembles the segments and passes them on for IP processing and forwarding. For outgoing packets, if fragmentation is required, it is stored at a temporary place and the co-processor fragments the entire packet before all fragments are transmitted sequentially out of the interface. A drawback of this approach is complexity and cost. There is an additional packet store-and-forward stage added to the packet processing path, which means additional memory requirement for packet storage and additional packet latency for forwarding. This increases cost and reduces network application throughput.

Therefore, what are needed are systems and methods for efficiently implementing IP fragmentation and reassembly for tunneled packets, possibly combined with encryption, decryption and forwarding, which is suitable for hardware pipelines of network switching processors.

### SUMMARY

A novel flow-through architecture for fragmentation and reassembly of tunnel packets in network devices is presented. The fragmentation and reassembly of tunneled packets are handled in the hardware pipeline to achieve line-rate processing of the traffic flow without the need for additional store and forward operations typically provided by a host processor or a co-processor. In addition, the hardware pipeline may perform fragmentation and reassembly of packets using encrypted tunnels by performing segment-by-segment crypto. A network device implementing fragment reassembly can include an ingress hardware pipeline that reassembles fragmented packets between a media access control (MAC) of the device and an output packet memory of the device, where the incoming fragmented packets can be encrypted and/or tunneled. A network device implementing packet fragmentation can include an egress hardware pipeline that fragments packets between an input packet memory of the device and the MAC, where the outgoing fragments can be encrypted and/or tunneled.

### BRIEF DESCRIPTION OF THE DRAWINGS

Aspects and features of this application will become apparent to those ordinarily skilled in the art from the following detailed description of certain embodiments in conjunction with the accompanying drawings, wherein:

FIG. 1 illustrates a typical generic routing encapsulation (GRE) tunnel protocol stack as is known in the art today;

FIG. 2 illustrates an exemplary processing flow for an egress hardware pipeline according to certain embodiments;

FIG. 3 illustrates an exemplary processing flow for an ingress hardware pipeline according to certain embodiments; and

FIGS. 4A-4D illustrate an exemplary data flow according to certain embodiments.

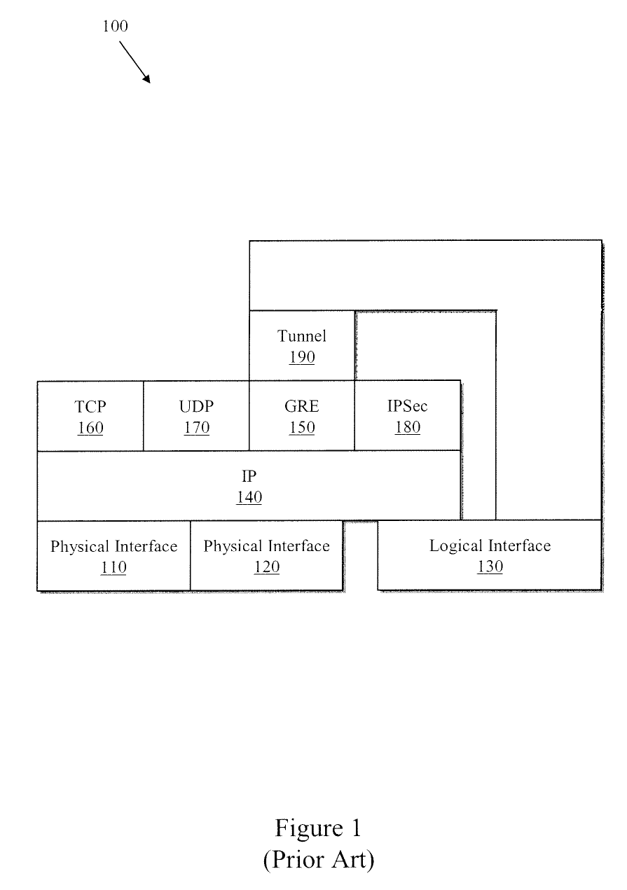

### DETAILED DESCRIPTION

Embodiments will now be described in detail with reference to the drawings, which are provided as illustrative examples of certain embodiment so as to enable those skilled in the art to practice the embodiments and are not meant to limit the scope of the application. Where aspects of certain embodiments can be partially or fully implemented using known components or steps, only those portions of such known components or steps that are necessary for an understanding of the embodiments will be described, and detailed description of other portions of such known components or steps will be omitted so as not to obscure the embodiments. Further, certain embodiments are intended to encompass presently known and future equivalents to the components referred to herein by way of illustration.

In certain embodiments, a novel flow-through implementation in the hardware pipeline for fragmentation and reassembly of tunnel packets attempts to solve at least some of the problems associated with the typical IP reassembly and fragmentation designs. The fragmentation and reassembly of tunneled packets are handled in the hardware pipeline without the need for any additional store and forward operations. In addition, certain embodiments can work with fragmented packets in encrypted tunnels, where fragments can be decrypted before they are reassembled, and where the fragmentation of a packet can happen before encrypting the fragments. As used herein, the words frame, packet, datagram, segment, message, cell, data, information and the like are not meant to be limiting to any particular network protocol, appliance or layer, but instead are generically meant to indicate any type information or data unit.

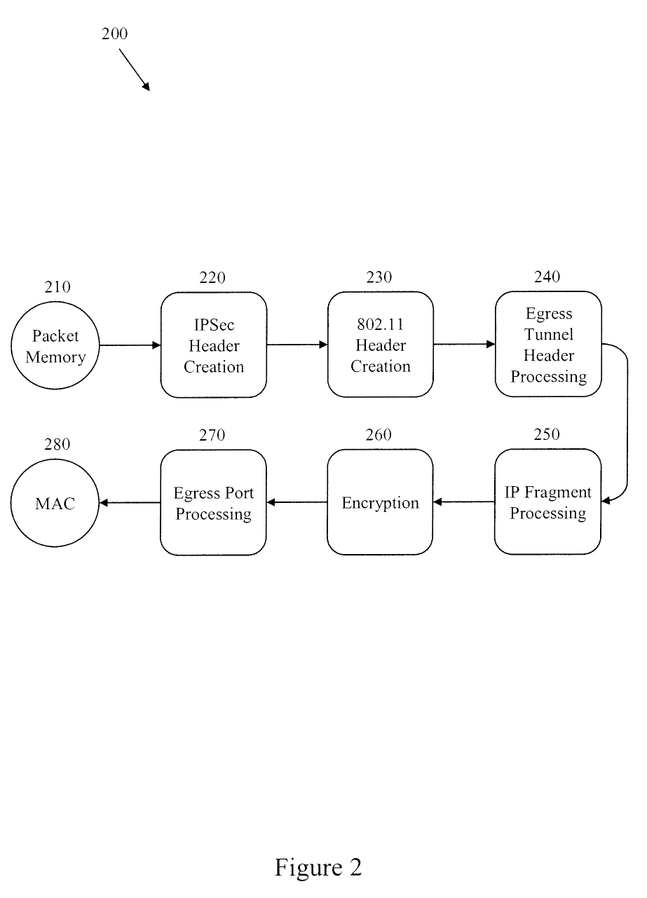

FIG. 2 illustrates an exemplary processing flow for an egress hardware pipeline 200 according to certain embodiments. Egress hardware pipeline 200 can, for example, be implemented in a network switching device. At egress, the data arrive via packet memory 210, which can be a centralized packet memory, and can go through IPSec header creation 220 and/or IEEE 802.11 header creation 230, as needed. If the data determined to need tunnel encapsulation, then encapsulation can occur via egress tunnel header processing 240. Of course, certain embodiments are intended to operate equally well on tunneled and non-tunneled data. If fragmentation is needed, then IP fragmentation processing 250 can be performed. As necessary, the data (e.g., fragments, packets, etc.) can go through encryption 260.

In certain embodiments, IP fragmentation in switching devices can be implemented at an egress processing stage. It should be noted that the blocks shown in the exemplary egress hardware pipeline of FIG. 2 are functional as well as physical, where device logic can be used to implement the functions shown within each block. For example, if egress logic within a network switching device that is implementing egress hardware pipeline 200 determines that a tunnel encapsulation may be needed, packet length for the current data can be compared against a port maximum transmission unit (MTU). If the current data size is larger than the port MTU size or the tunnel path MTU, then the fragmentation processing 250 can be invoked. The packet is fragmented as it flows through the egress hardware pipeline. For each IP fragment that is processed, the IP header can be generated and sent out first. The relevant part of the original IP payload will be read out from the packet buffer memory and attached at the end of the IP header in a size that is less than the applicable MTU size. For certain embodiments, care should be taken to ensure that the payload attached is a multiple of 8 bytes. This process can be repeated for each fragmented segment until all of the data are sent out. Finally, after egress port processing 270, the data can be transmitted via media access control (MAC) 280.

In certain embodiments, IP fragmentation may be needed for packets that are to be transmitted as encrypted packets. In that case, the packet can be fragmented 260 in the egress hardware pipeline taking into account constraints in payload size imposed by the specific cryptographic algorithms used. For example, when using the Advanced Encryption Standard with Cipher Block Chaining (AES-CBC), all fragments except the last fragment should have a payload that is a multiple of 16 bytes. As each fragment is created, it is sent through the encryption block and the encryptor encrypts the payload. Some state is retained once a fragment is encrypted and this state is utilized to initiate the encryption for the next fragment. Segment-by-segment encryption can be performed to accomplish flow-through fragmentation as described in commonly-assigned and co-pending U.S. patent application Ser. No. 11/351,331 filed on Feb. 8, 2006 and entitled “Methods and Systems for Incremental Crypto Processing of Fragmented Packets,” which is fully incorporated herein by reference for all purposes.

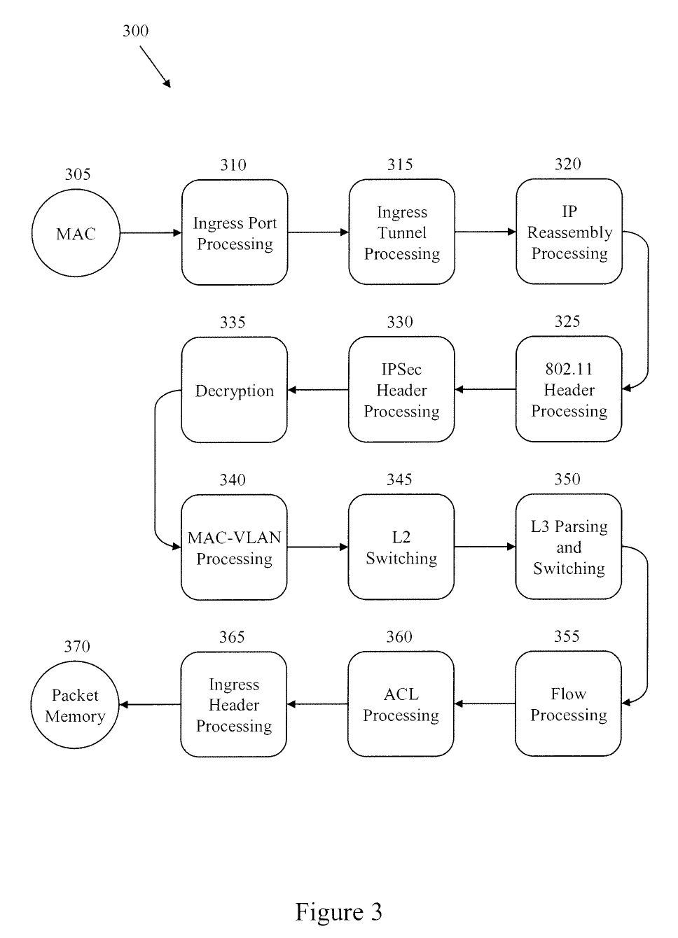

FIG. 3 illustrates an exemplary processing flow for an ingress hardware pipeline 300 according to certain embodiments. Ingress hardware pipeline 300 can, for example, be implemented in a network switching device. As shown in FIG. 2, packets coming in from a MAC 305 can first go through ingress port processing 310. Next, ingress tunnel processing 315, if determined to be required, and IP reassembly processing 320 can parse and process the incoming fragmented IP tunnel packets. Of course, certain embodiments are intended to operate equally well on tunneled and non-tunneled data. This exemplary pipeline flow can then process, as applicable, IEEE 802.11 header 325 and/or IP security (IPSec) header 330. Decryption 335 and/or virtual local area network (VLAN) processing 340 can occur at this stage, as needed. After decryption 335 and/or VLAN processing 340, the frame can go through L2 switching 345, L3 parsing and switching 350, flow processing 355, and access control list (ACL) processing 360. Finally, after ingress header processing 365, the data are stored in packet memory 370, which can be a centralized packet memory. As used herein, step 325 through, and including, step 365, may be referred to herein as segment processing functions.

In certain embodiments, an exemplary switching device can implement flow-through reassembly of fragmented packets as part of ingress hardware pipeline 300. It should be noted that the blocks shown in the exemplary ingress hardware pipeline of FIG. 3 are functional as well as physical, where device logic can be used to implement the functions shown within each block. Once a packet is identified as a tunneled packet, each IP fragmentation segment can move through the ingress pipeline independently and ultimately queued at the packet memory. For fragmentation segments, the first IP segment generally contains the protocol header information. Thus, L2/L3 switching/process 345, 350 and ACL/firewall processing 340, 355, 360 can be applied only to the first fragmentation segment. The fragmentation segment(s) following the first fragmentation segment can use the stored packet context from the first segment when it was processed by the hardware pipeline. All segments can then be queued inside packet memory 370 and need not be forwarded to an egress queue until all of the fragmentation segments for that data unit have arrived. Egress logic can be responsible of combining (e.g., stitching, merging, joining, etc.) the fragmentation segments together before forwarding the reassembled data. Alternatively, the fragments can be combined together prior to queuing inside packet memory 370 and then forwarded.

Certain embodiments can be used for flow-through reassembly of clear as well as encrypted tunnels. If a tunnel identified as part of ingress hardware pipeline 300 is an encrypted tunnel (e.g. IPSec tunnel, PPP-SSH, CIPE, etc.), certain embodiments can use decryption logic to handle decryption on a segment-by-segment basis, the results of which can be combined together during the reassembly process after the last segment arrives. For example, segment-by-segment decryption can be performed to accomplish flow-through reassembly of encrypted fragments as described in commonly-assigned and co-pending U.S. patent application Ser. No. 11/351,331 filed on Feb. 8, 2006 and entitled “Methods and Systems for Incremental Crypto Processing of Fragmented Packets,” which is fully incorporated herein by reference for all purposes.

In certain embodiments, incoming non-fragmented packets can run through tunnel table processing where all tunneled packets are identified. If the incoming packet is encrypted it goes through decryption. In the case where it is a clear tunnel packet, i.e., packets on the tunnel are not encrypted, the decryption processing is bypassed. The decrypted (or clear tunnel) packet is then subjected to L2/L3 switching and/or firewall/ACL processing, as appropriate, and if needed, the inner header is updated. The inner header editing can do minor updates, such as, for example, updating the IP DiffServ Code Point (DSCP) for the inner packet if needed by ACL. The decrypted packet is then stored in a packet buffer in packet memory and the pointer to the packet buffer is queued into the egress queue. Based on the scheduling criteria, the packet buffer can be dequeued by the scheduler and sent for egress processing.

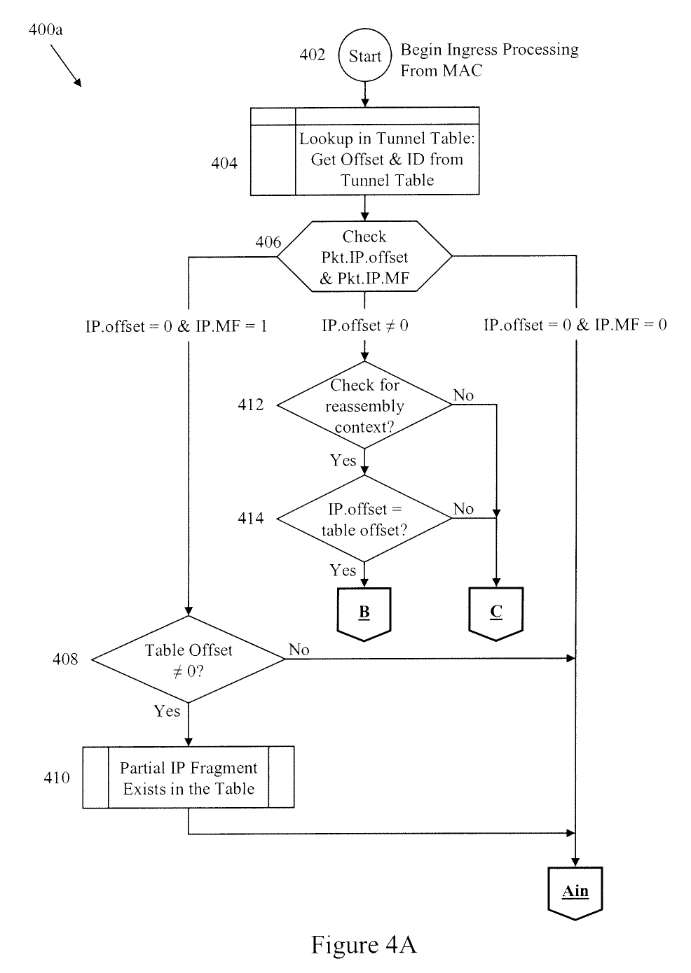

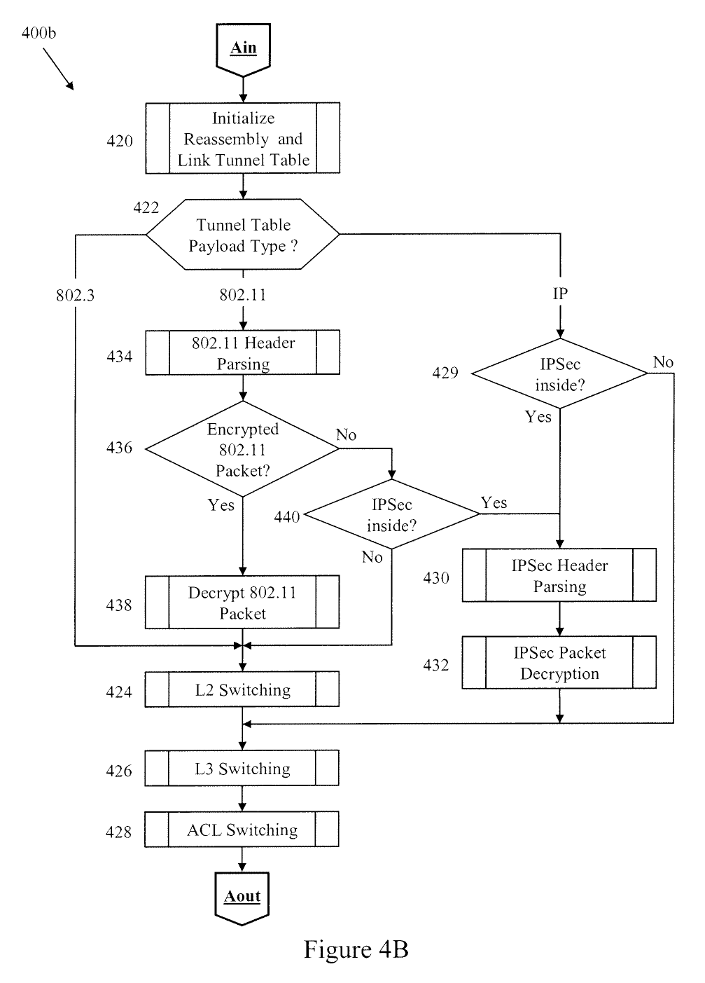

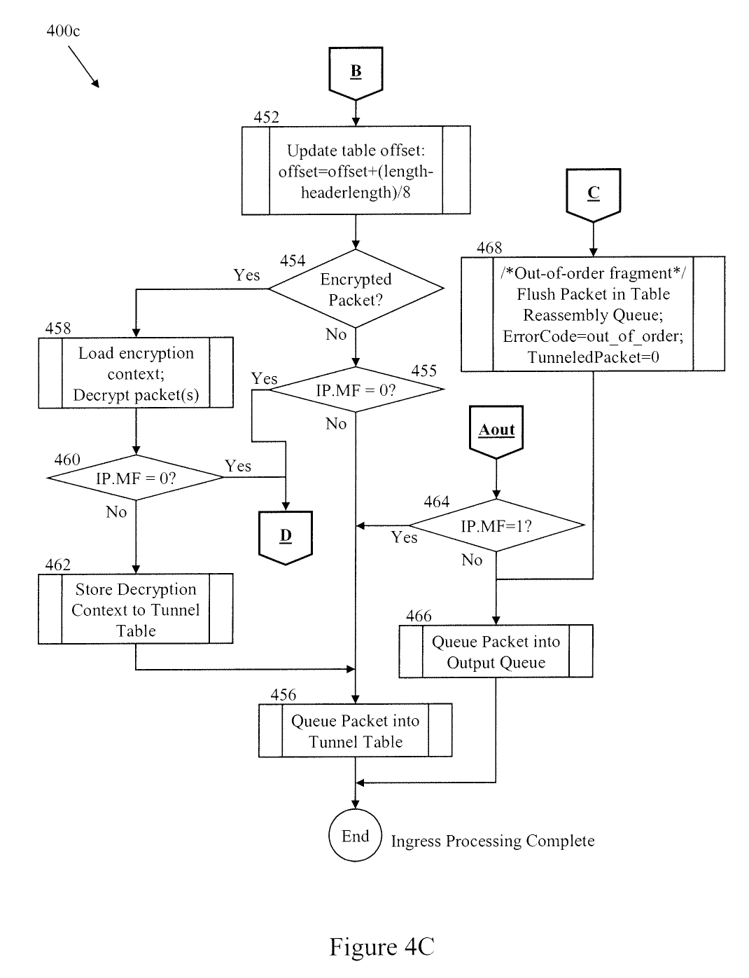

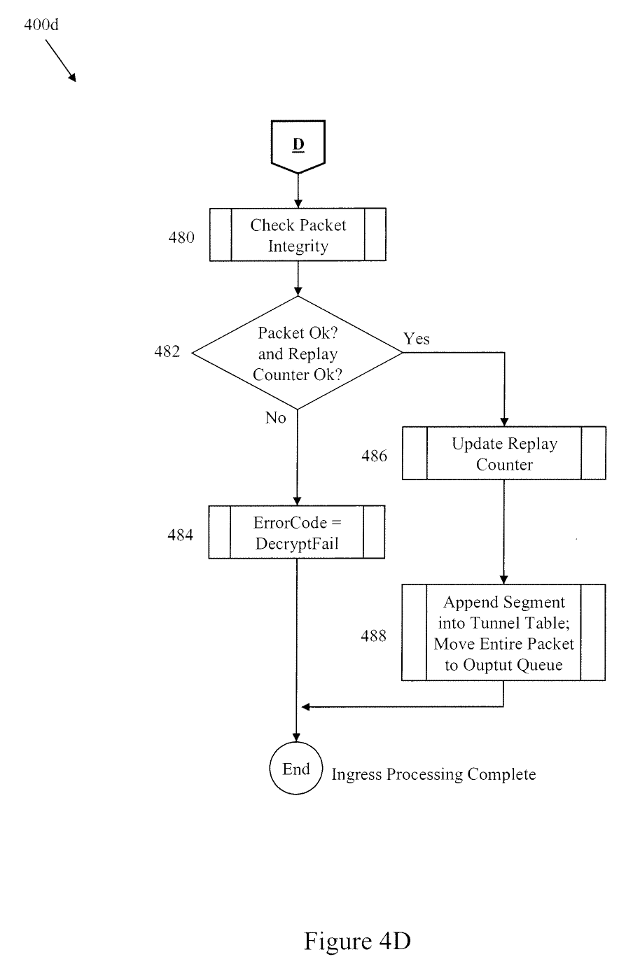

FIGS. 4A-4D illustrate an exemplary data flow 400a-d according to certain embodiments. For ease of discussion and implementation, exemplary data flow 400a-d assumes that fragments arriving on a tunnel are in order; that is, for a particular tunnel, the IP fragments of a packet or datagram (e.g., fragment1, fragment2, fragment3, etc.) arrive in sequence and there are no interleaved or out-of-order fragments. In data flow 400a-d, out of order fragments that arrive are pushed to an external processor for reassembly. However, as will be subsequently discussed, exemplary data flow 400a-d can be expanded to include the handling of out-of-order fragments without requiring external processor reassembly.

As shown in FIG. 4A, data flow 400a starts ingress processing from a MAC 402. From there, at step 404, the table tunnel offset and ID are retrieved from the tunnel table. At step 406, the packet IP header more fragments flag (Pkt.IP.MF) and packet fragment offset field (Pkt.IP.offset) are checked. Depending on the state of the MF flag and the offset field, the ingress processing can be different (i.e., the first fragment, the intermediate fragments and the last fragment are processed differently).

From step 406, if the MF flag in the IP header is set (i.e., MF=1) and the OFFSET field in the IP header is 0, this packet is the first, or initial, fragment of an IP datagram. Most of the processing for the first fragment is the same as for non-fragmented packets (discussed above). The detailed processing of the first fragment begins at step 408, where the previously retrieved tunnel table offset is checked for a non-zero value. If the tunnel table offset is non-zero, then a partial IP fragment exists in the tunnel table and, as discussed further below, the IP reassembly queue should ultimately be flushed because, as previously noted, this incoming packet is the first fragment of an IP datagram. At this point, flow 400a transfers to flow 400b via connector Ain.

As shown in FIG. 4B, flow 400b begins at step 420. If the tunnel table offset is zero, the IP reassembly flow is initialized and an entry that is linked to the tunnel table is created 420 (i.e., next header offset updated, tunneled packet indicator set, and source IP address, destination IP address, protocol, ID, and offset should be stored in the tunnel table, and the like). At this point, the tunnel table can be checked to determine the payload type for this initial fragment 422. The payload type can be, for example, IEEE 802.3, IP, or IEEE 802.11. However, additional payload types are meant to be within the scope of certain embodiments.

If the payload check at step 422 indicates an IEEE 802.3 type, then L2, L3 switching and/or ACL processing 424, 426, 428 are performed normally, as necessary, and flow control is passed through connector Aout. If the payload check at step 422 indicates and/or ACL processing 426, 428 are performed normally and flow control is passed through connector Aout. However, if IPSec is inside at step 429, then IPSec header parsing and decryption 430, 432 can be performed prior to L3 switching and/or ACL processing 426, 428, followed by passing flow control through connector Aout.

If the payload check at step 422 indicates an IEEE 802.11 type, 802.11 header parsing 434 can be performed. Then the 802.11 packet can be checked for encryption 436. If the packet is encrypted, then it can be decrypted 438 and L2/L3 switching and/or ACL processing 424, 426, 428 are performed, as necessary, and flow control is passed through connector Aout. If the 802.11 packet is not encrypted, it can be further checked for IPSec 440. If IPSec is inside of the 802.11 packet, then IPSec parsing and decryption 430, 432 can be performed prior to L3 switching and/or ACL processing 426, 428, followed by passing flow control through connector Aout. If the 802.11 packet is not encrypted and IPSec is not inside, then L2/L3 switching and/or ACL processing 424, 426, 428 are performed, as necessary and flow control is passed through connector Aout. For each of these payload types, firewall processing (not shown) can additionally be performed as necessary.

For certain embodiments, discussed previously in relation to flow 400b, decryption logic decrypts the fragment and packet format information and the pointer to the decryption context can be stored in the tunnel table. A temporary decryption state can also be stored in the tunnel table. Additionally, an intermediate packet integrity check value can be calculated for the segment and the result can be stored in the tunnel table. No replay counter update is performed at this point in the flow as the packet has not yet been authenticated.

As shown in FIG. 4C, from connector Aout in flow 400c, the fragment is checked to see whether MF is set 460 (i.e., which for this first, initial fragment of the datagram, MF=1). Since MF is set, the fragment (decrypted if necessary) is stored in packet memory 456. However, instead of using the egress queue, the packet pointer is queued into a separate IP reassembly queue. This IP reassembly queue is maintained on a per tunnel basis. If there is a previous segment queued in the tunnel table when the current first fragment arrives, it needs to send the segment to host before it can queue the new IP segment. This means that if there is a partial IP fragment in this reassembly context, it is flushed out to the host once a new, first fragment arrives for processing. Once queued, the ingress processing for this first fragment is complete.

Returning the step 406 of flow 400a in FIG. 4A, if the OFFSET field in the IP header is non-zero and the MF bit in the IP header is 1, then the incoming segment is a non-initial fragment of an IP datagram. This fragment will not have protocol header for normal processing. The switching device implementing certain embodiments should perform the following operations for the segment. First, at step 412, a lookup is performed against the tunnel table using source IP address, destination IP address, protocol and ID to see whether the reassembly context exists. If not, the packet should be sent to the host for regular packet processing (discussed below with reference to connector C). If a reassembly context is found, IP reassembly processing logic should retrieve the offset from the tunnel table and compare it against the IP.OFFSET field in the incoming packet 414. If the tunnel table offset and the IP.OFFSET do not match, then this is an out-of-order IP fragment (discussed below with reference to connector C). If the offset value in the segment matches the one stored in the tunnel table, then flow 400a is passed through connector B to flow 400c.

As shown in FIG. 4C, flow 400c begins at connector B by updating the offset field in the tunnel table using the IP total length field 452 (i.e., new_offset=old_offset+(length−header_length)/8). Next, at step 454, the segment is checked to see whether it is encrypted. If the segment is not encrypted, then because for this segment MF=1 455, it can be queued 456 and processing ends for this segment. If the segment is encrypted, the decryptor may need to retrieve decryption information using the tunnel table. The packet format, crypto algorithm and key information can all be retrieved using the tunnel table 458. Crypto key, algorithm, temporary decryption and message integrity check information are read out using the tunnel table so the packet can be decrypted via decryption logic 458. After decryption, because for this segment MF=1 460, the intermediate decryption and message integrity check information are stored back to the tunnel table 462, as described above. Since there is no L2/L3 inner header for this intermediate fragment, all of the L2/L3 switching and/or firewall/ACL processing can be bypassed and the segment can be queued into the IP reassembly queue 456.

As shown in FIG. 4C, if, for this intermediate fragment, either the reassembly context does not exist or the offsets do not match, then beginning at connector C, this segment is marked as out-of-order 468. When such a fragment is marked as out-of-order, all of the fragments queued in the IP reassembly queue, as applicable, along with the current segment is forwarded to the host for out-of-order reassembly processing 466.

Returning to step 406 of flow 400a in FIG. 4A, if the IP.OFFSET is non-zero and IP.MF is 0, then the incoming frame, or segment, is the last fragment of an IP datagram. The switching device implementing certain embodiment should do the following, in addition to the steps described above for ingress processing of an intermediate fragment. After decryption 458 for the encrypted packet or after determining that the packet is not encrypted 454, as shown in flow 400c of FIG. 4C, the processing is transferred through connector D because MF=0 at step 460 or 455. As shown in FIG. 4D, in addition to packet decryption, decryption processing performs a packet integrity check 480. If the packet integrity of the replay counter (i.e., via tunnel table replay counter retrieval) are invalid 482, the packet should be marked as an error and error processing can be formed (i.e., drop or forward to host). If the packet integrity and replay counter are valid, 482, the switching device can update the replay counter 486 and move the entire packet to egress queue using the QueueId stored in the tunnel table 488. As a group, steps 480 through, and including, step 488 may be referred to herein as segment verification processing. All the pointers can then be moved from the IP reassembly queue to the output queue where they can be scheduled for egress processing. On egress these fragments are merged together before forwarding 488.

In certain embodiments, the exemplary data flow described in FIGS. 4A-4D, above, can be enhanced to support interleaved IP fragments on a tunnel. In this example, it will be assumed that the first fragment for each of the interleaved IP fragments has arrived prior to the other fragments for a given fragmented datagram. This first fragment will initialize the IP flow reassembly context for that datagram. In such a scenario, the processing for clear and encrypted tunnels is slightly different.

For clear tunnels, the ingress packet processing is the same as above with respect to FIGS. 4A-4D, except that the IP reassembly flow context does not have the IP offset and the checks related to the IP offset are not performed. The IP reassembly queue mentioned above can be maintained as an ordered list. The IP reassembly queue is ordered based on the fragment offset in the IP header. At the time of enqueuing each fragment, a check can be performed to find if all the intermediate fragments and the last fragment have already arrived. If this check is true, then all of the packets in the IP reassembly queue can be moved to the output queue where they are scheduled for egress processing. If a first fragment arrives, when there are still some fragments from the previous packet that have not been moved to the egress queue, then those fragments are sent to the host for out-of-order processing.

For encrypted tunnels, the ingress processing can be accomplished in two passes. On finding an out of order IP fragment, the fragment is not decrypted as the intermediate decryption context cannot be used to decrypt out of order fragments. At time of enqueuing such a fragment, a special flag namely, for example, “isEncrypted” can be set for these fragments to indicate that they arrived out of order. Here too, the IP reassembly queue can be maintained as an ordered list with IP offset in the IP header forming the basis for ordering.

At the time of enqueuing, the IP reassembly queue is traversed to figure out whether there has been a fragment which is marked with the “isEncrypted” flag and for which the previous fragment has arrived and been enqueued with this flag not set. If such a fragment is found, then it is looped back into the pipeline and ingress processing is performed for such packets. During ingress processing these fragments can be decrypted. If at the time of enqueuing the fragments into the IP reassembly queue it is found that all the intermediate fragments and the last fragment have arrived and the “isEncrypted” flag is false for all the enqueued fragments, then the fragments are moved to the output queue and the rest of the egress processing is the same as discussed above.

Certain embodiments can support the need to reassemble IP fragments from multiple IP packets belonging to a tunnel. In such embodiments, multiple IP reassembly flow contexts can be maintained per tunnel. The rest of the data processing is similar to the one described above with reference to FIGS. 4A-4D.

Although certain embodiments described above illustrate a mechanism for reassembling tunneled packets and fragmentation of tunneled packets, these embodiments can be easily extended to include the reassembly and/or fragments of non-tunneled IP datagrams. If non-tunneled IP packets need to be reassembled, then the IP reassembly flow entry is created for every source IP address, destination IP address, protocol and ID. Further, the IP reassembly flow entry keeps a pointer to the stored IP fragments in the memory. The rest of reassembly mechanism is similar to certain embodiments described above. Likewise, if an IP packet needs fragmentation, but is not tunneled, the egress process can simply not perform egress tunnel header creation and the rest of the fragmentation mechanism is similar to certain embodiments described above.

Although the application has been particularly described with reference to embodiments thereof, it should be readily apparent to those of ordinary skill in the art that various changes, modifications, substitutes and deletions are intended within the form and details thereof, without departing from the spirit and scope of the application. Accordingly, it will be appreciated that in numerous instances some features of certain embodiments will be employed without a corresponding use of other features. Further, those skilled in the art will understand that variations can be made in the number and arrangement of inventive elements illustrated and described in the above figures. It is intended that the scope of the appended claims include such changes and modifications.

What is claimed is:

1. A method for inline fragment reassembly of tunneled data, comprising the steps of:
receiving an initial segment of a plurality of tunneled segments of a first fragmented packet;
processing the initial segment;
storing the initial segment in a memory;
receiving a last segment of the plurality of tunneled segments of the first fragmented packet;
processing the last segment;
storing the last segment in the memory;
moving the plurality of tunneled segments to an output queue; and
stitching together the plurality of tunneled segments to form a reassembled packet.

2. The method of claim 1, wherein the step of processing the initial segment includes the steps of:
initializing a reassembly flow, including:
linking one or more portions of a header of the initial segment to a tunnel table; and
initializing an IP reassembly queue,
wherein the tunnel table and the IP reassembly queue are part of an ingress hardware pipeline;
detecting a payload type;
performing, based on the payload type, one or more segment processing functions.

3. The method of claim 2, wherein based on the detected payload type being an encrypted payload type, the one or more segment processing functions include:
parsing encryption information; and
decrypting the initial segment.

4. The method of claim 2, further including the steps of:
storing a fragment context into the tunnel table, wherein the fragment context includes one or more of items selected from a group of items, the group of items including a packet ID, a source address, a destination address, an offset value, a packet format and an encryption context; and
queuing an initial pointer associated with the initial segment into the IP reassembly queue.

5. The method of claim 4, wherein the step of processing the last segment includes the steps of:
updating at least some of the fragment context;
detecting whether the last segment is encrypted; and
performing segment verification processing.

6. The method of claim 5, wherein for an encrypted last segment, further including the steps of, prior to the step of performing segment verification processing:
loading the encryption context of the fragment context from the tunnel table; and
decrypting the next segment.

7. The method of claim 4, further comprising the steps of, prior to the step of receiving the last segment:
receiving an intermediate segment of the plurality of tunneled segments of the first fragmented packet;
processing the intermediate segment; and
storing the intermediate segment in the memory.

8. The method of claim 7, wherein the step of processing the intermediate segment includes the steps of:
updating at least some of the fragment context;
detecting whether the intermediate segment is encrypted; and
performing segment verification processing.

9. The method of claim 8, wherein for an encrypted intermediate segment, further including the steps of, prior to the step of performing segment verification processing:
loading the encryption context of the fragment context from the tunnel table;
decrypting the intermediate segment;
storing the decryption context of the fragment context into the tunnel table; and
queuing an intermediate pointer associated with the intermediate segment into the IP reassembly queue.

10. A device for inline fragment reassembly of tunneled data, comprising:
means for receiving an initial segment of a plurality of tunneled segments of a first fragmented packet;
means for processing the initial segment;
means for storing the initial segment in a memory;
means for receiving a last segment of the plurality of tunneled segments of the first fragmented packet;
means for processing the last segment;
means for storing the last segment in the memory;
means for moving the plurality of tunneled segments to an output queue; and
means for stitching together the plurality of tunneled segments to form a reassembled packet.

11. A method for inline fragmentation of tunneled data, comprising the steps of:
receiving a packet from a packet memory;
determining tunnel encapsulation is required for the packet;
determining fragmentation is required for the packet;
creating a header for an initial segment of a plurality of segments for the packet;
transmitting the header and the initial segment, wherein the initial segment is an initial piece of the packet that is of a certain size;
creating the header for a next segment of the plurality of segments for the packets; and
transmitting the header and the next segment,
wherein the next segment is a next piece of the packet that is of the certain size.

12. The method of claim 11, further including the steps of:
determining encryption is required for the packet; and
as part of the steps of transmitting each of the initial and next segments, encrypting the initial and next segments.

13. A device for inline fragmentation of tunneled data, comprising:
means for receiving a packet from a packet memory;
means for determining tunnel encapsulation is required for the packet;
means for determining fragmentation is required for the packet;
means for creating a header for an initial segment of a plurality of segments for the packet;
means for transmitting the header and the initial segment, wherein the initial segment is an initial piece of the packet that is of a certain size;
means for creating the header for a next segment of the plurality of segments for the packets; and
means for transmitting the header and the next segment,
wherein the next segment is a next piece of the packet that is of the certain size.

14. The device of claim 13, further including:
means for determining encryption is required for the packet; and
as part of the means for transmitting each of the initial and next segments, means for encrypting the initial and next segments.

15. A device, comprising:
an ingress hardware pipeline that reassembles a plurality of incoming segments into a packet between a media access control (MAC) of the device and an output packet memory of the device.

16. The device of claim 15, wherein the plurality of incoming segments is a plurality of incoming tunneled segments.

17. The device of claim 16, wherein the plurality of incoming tunneled segments are encrypted.

18. The device of claim 15, further comprising:
an egress hardware pipeline that fragments a packet into a plurality of outgoing segments between an input packet memory of the device and the MAC.

19. The device of claim 18, wherein the plurality of outgoing segments is a plurality of outgoing tunneled segments.

20. The device of claim 19, wherein the plurality of outgoing tunneled segments are encrypted.

21. A device, comprising:
an egress hardware pipeline that fragments a packets into a plurality of segments between an input packet memory of the device and the media access control (MAC) of the device.

22. The device of claim 21, wherein the plurality of segments is a plurality of tunneled segments.

23. The device of claim 22, wherein the plurality of tunneled segments are encrypted.
